(19) United States
(12) Patent Application Publication
(10) Pub. No.: US 2019/0069310 A1
(43) Pub. Date: Feb. 28, 2019

(54) PREDICTING RESOURCE UNIT ALLOCATIONS IN A WIRELESS NETWORK

(71) Applicant: QUALCOMM Incorporated, San Diego, CA (US)

(72) Inventors: Dustin Andrew Brown, San Diego, CA (US); Houston Hoffman, San Diego, CA (US); Rajeev Kumar, San Diego, CA (US)

(21) Appl. No.: 15/684,692

(22) Filed: Aug. 23, 2017

(51) Int. Cl. H04W 72/12; H04W 72/04; H04W 72/10; H04W 28/02; H04W 74/04

(52) U.S. Cl. CPC H04W 72/121; H04W 72/042; H04W 72/0486; H04W 84/12; H04W 72/10; H04W 28/0289; H04W 74/04; H04W 72/0453

(57) ABSTRACT

This disclosure provides systems, methods and apparatuses for allocating resource units (RUs) to stations (STAs) in a wireless local area network (WLAN). In some implementations, a wireless device such as an access point may determine a number of transmission control protocol (TCP) acknowledgement (ACK) messages transmitted to each of a plurality of stations (STAs) in a wireless network during a first time period, and may allocate a number of resource units (RUs) to one or more of the STAs during a second time period based at least in part on the determined numbers of TCP ACK messages. The wireless device may transmit a trigger frame indicating the allocation of the number of RUs to the one or more STAs.

### TECHNICAL FIELD

This disclosure relates generally to wireless networks, and specifically to scheduling allocations of resource units for wireless communications.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within wireless range of the AP to establish and maintain a communication link with the WLAN. WLANs that operate in accordance with the IEEE 802.11 family of standards are commonly referred to as Wi-Fi networks, and client devices that communicate with the AP in a Wi-Fi network may be referred to as wireless stations (STAs).

In older or “legacy” Wi-Fi networks, wireless devices (such as APs and STAs) typically compete with each other for access to the shared wireless medium. For example, wireless devices may use carrier sense multiple access with collision avoidance (CSMA/CA) techniques to “listen” to the wireless medium to determine when the wireless medium is idle. When the wireless medium has been idle for a given duration, the wireless devices may contend for medium access by waiting a random “back-off” period before attempting to transmit on the wireless medium. The wireless device having the shortest back-off period wins the contention operation, and may be granted exclusive access to the shared wireless medium for a period of time commonly referred to as a transmit opportunity (TXOP).

Recent revisions to the IEEE 802.11 specification introduce multiple channel access mechanisms that allow multiple STAs to transmit and receive data on a shared wireless medium at the same time. For example, the frequency spectrum of a wireless network may be divided into a plurality of unique resource units (RUs) each including a number of different frequency subcarriers. A trigger frame may be used to allocate a number of unique RUs to a plurality of STAs for a given time period. Each of the plurality of STAs may transmit or receive data during the given time period using the unique RU(s) allocated by the trigger frame. In this manner, multiple STAs may transmit or receive data at the same time without contending for medium access.

### SUMMARY

The systems, methods and devices of this disclosure each have several innovative aspects, no single one of which is solely responsible for the desirable attributes disclosed herein.

One innovative aspect of the subject matter described in this disclosure may be implemented as a method for allocating medium resources to a plurality of stations (STAs) in a wireless network. The method may include determining a number of transmission control protocol (TCP) acknowledgement (ACK) messages transmitted to each of the plurality of STAs during a first time period, allocating a number of resource units (RUs) to one or more of the STAs during a second time period based at least in part on the determined numbers of TCP ACK messages, and transmitting a trigger frame indicating the allocation of the number of RUs to the one or more STAs. In some implementations, the method may include assigning a priority level to each of the plurality of STAs based on the determined number of TCP ACK messages, and allocating the number of RUs to the one or more STAs based at least in part on the assigned priority levels. In some implementations, the method may also include allocating a first number of RUs to each of the STAs having a first priority level, and allocating a second number of RUs to each of the STAs having a second priority level (where the first number of RUs is greater than the second number of RUs, and the first priority level is higher than the second priority level).

In other implementations, the method may include predicting an amount of TCP data transmissions from a selected one of the STAs during the second time period based on the determined number of TCP ACK messages transmitted to the selected STA during the first time period, the second time period after the first time period, and scheduling an allocation of one or more RUs to the selected STA during the second time period based at least in part on the predicted amount of TCP data transmissions.

In addition, or in the alternative, the method may include determining a traffic level of the wireless network, and allocating the RUs to the one or more STAs based at least in part on the determined traffic level. In some implementations, the method may also include indicating a high traffic condition based on a level of traffic in the wireless network exceeding a value, and postponing transmission of the trigger frame if the high-traffic condition is indicated.

Another innovative aspect of the subject matter described in this disclosure may be implemented in a wireless device including one or more processors and a memory configured to store instructions. Execution of the instructions by the one or more processors may cause the wireless device to determine a number of transmission control protocol (TCP) acknowledgement (ACK) messages transmitted to each of a plurality of stations (STAs) in a wireless network during a first time period, allocate a number of resource units (RUs) to one or more of the STAs during a second time period based at least in part on the determined numbers of TCP ACK messages, and transmit a trigger frame indicating the allocation of the number of RUs to the one or more STAs.

Another innovative aspect of the subject matter described in this disclosure may be implemented in a non-transitory computer-readable medium. The non-transitory computer-readable medium may comprise instructions that, when executed by one or more processors of a wireless device, cause the wireless device to perform a number of operations. The number of operations may include determining a number of transmission control protocol (TCP) acknowledgement (ACK) messages transmitted to each of a plurality of STAs during a first time period, allocating a number of resource units (RUs) to one or more of the STAs during a second time period based at least in part on the determined numbers of TCP ACK messages, and transmitting a trigger frame indicating the allocation of the number of RUs to the one or more STAs.

Another innovative aspect of the subject matter described in this disclosure may be implemented in a wireless device. The wireless device may include means for determining a number of transmission control protocol (TCP) acknowledgement (ACK) messages transmitted to each of a plurality of STAs during a first time period, means for allocating a number of resource units (RUs) to one or more of the STAs during a second time period based at least in part on the determined numbers of TCP ACK messages, and means for transmitting a trigger frame indicating the allocation of the number of RUs to the one or more STAs.

### BRIEF DESCRIPTION OF THE DRAWINGS

FIG. 1 shows a block diagram of an example wireless system.

FIG. 2 shows a block diagram of an example wireless device.

FIGS. 3A-3C show example subcarrier allocations and resource unit distributions within different channel bandwidths.

FIG. 4 shows a timing diagram depicting an example operation using trigger frames to allocate resource units (RUs) to one or more wireless stations.

FIG. 5 shows an illustration depicting an example allocation of resource units based on a number of transmission control protocol (TCP) acknowledgement (ACK) messages received by the wireless devices.

FIG. 6A shows an illustrative flow chart depicting an example operation for allocating wireless medium resources to wireless devices.

FIG. 6B shows an illustrative flow chart depicting an example operation for allocating a number of RUs to one or more wireless devices.

FIG. 6C shows an illustrative flow chart depicting an example operation for transmitting a trigger frame.

FIG. 7A shows an illustrative flow chart depicting an example operation for allocating a number of RUs to one or more wireless devices.

FIG. 7B shows an illustrative flow chart depicting another example operation for allocating a number of RUs to one or more wireless devices.

FIG. 8 shows an example trigger frame.

FIG. 9A shows an example Common Info field of a trigger frame.

FIG. 9B shows an example Per User Info field of a trigger frame.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 802.11 specifications, or any of the IEEE 802.15 specifications, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may be used to reduce latencies resulting from network traffic by allocating resource units (RUs) to one or more stations (STAs) in a wireless network based on a number of TCP ACK messages received by each of the STAs. The number of TCP ACK messages received by each of the STAs may be determined from previous data transmissions or receptions associated with each of the STAs. Because a STA typically requests more data in response to receiving a TCP ACK message, the number of TCP ACK messages received by a respective STA may be used to predict an amount of TCP data to be transmitted or received by the STA in one or more subsequent time periods. In some implementations, the predicted amounts of TCP data that may be transmitted or received by each of the STAs may be used to schedule allocations of RUs to the STAs for a number of subsequent TXOPs. In some aspects, a greater amount of RUs may be allocated to STAs which are predicted to transmit or receive a relatively large amount of TCP data than to STAs which are predicted to transmit or receive a relatively small amount (or no amount) of TCP data. In other aspects, RUs may be allocated more frequently to STAs which are predicted to transmit or receive a relatively large amount of TCP data than to STAs which are predicted to transmit or receive a relatively small amount (or no amount) of TCP data. In this manner, aspects of the present disclosure may ensure that sufficient network resources are (and will be) available to accommodate data transmissions associated with ongoing TCP sessions.

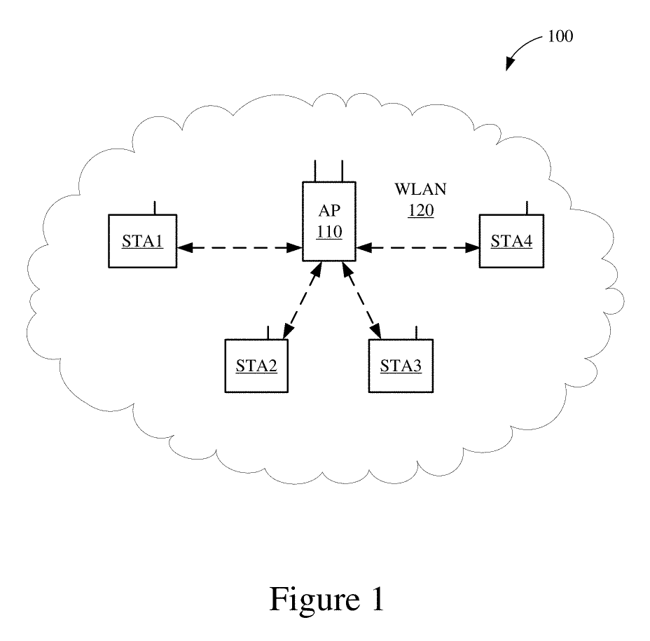

FIG. 1 shows a block diagram of an example wireless system 100. The wireless system 100 is shown to include four wireless stations STA1-STA4, a wireless access point (AP) 110, and a wireless local area network (WLAN) 120. The WLAN 120 may be formed by a plurality of access points (APs) that may operate according to the IEEE 802.11 family of specifications (or according to other suitable wireless protocols). Thus, although only one AP 110 is shown in FIG. 1 for simplicity, it is to be understood that WLAN 120 may be formed by any number of access points such as AP 110. The AP 110 may be assigned a unique MAC address that is programmed therein by, for example, the manufacturer of the access point. Similarly, each of the stations STA1-STA4 also may be assigned a unique MAC address. Although not specifically shown in FIG. 1, for at least some implementations, the stations STA1-STA4 may exchange signals directly with each other (such as without the presence of the AP 110).

In some implementations, the wireless system 100 may correspond to a multiple-input multiple-output (MIMO) wireless network, and may support single-user MIMO (SU-MIMO) and multi-user (MU-MIMO) communications. For other implementations, the wireless system 100 may correspond to or utilize orthogonal frequency division multiple access (OFDMA) communications. Further, although the WLAN 120 is depicted in FIG. 1 as an infrastructure Basic Service Set (BSS), for other implementations, WLAN 120 may be an Independent Basic Service Set (IBSS), an Extended Service Set (ESS), an ad-hoc network, or a peer-to-peer (P2P) network (such as operating according to Wi-Fi Direct protocols).

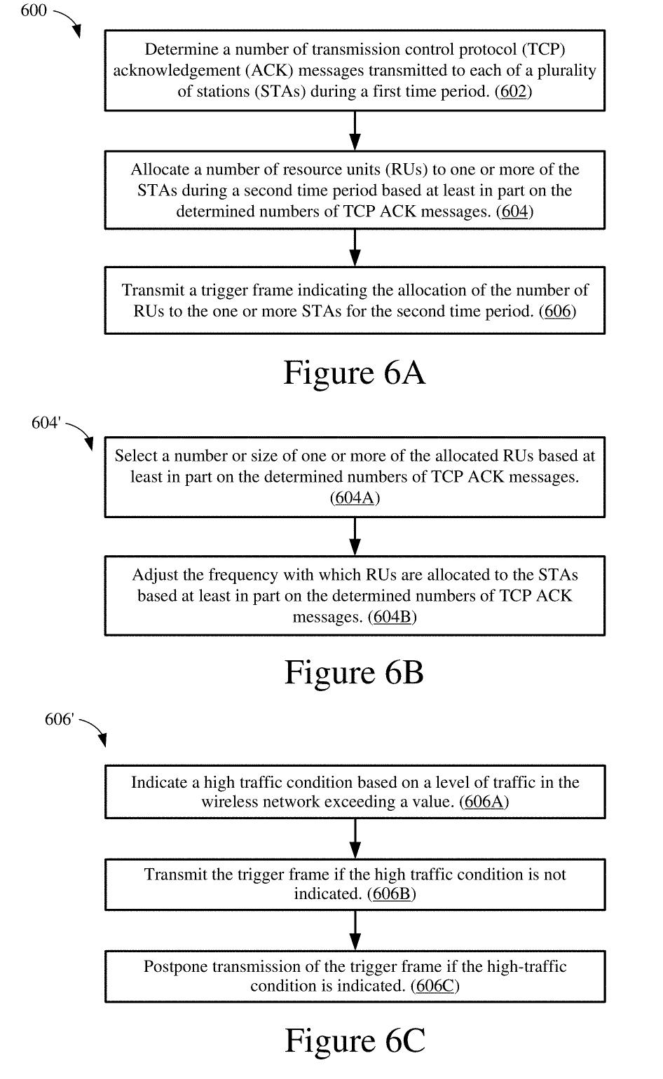

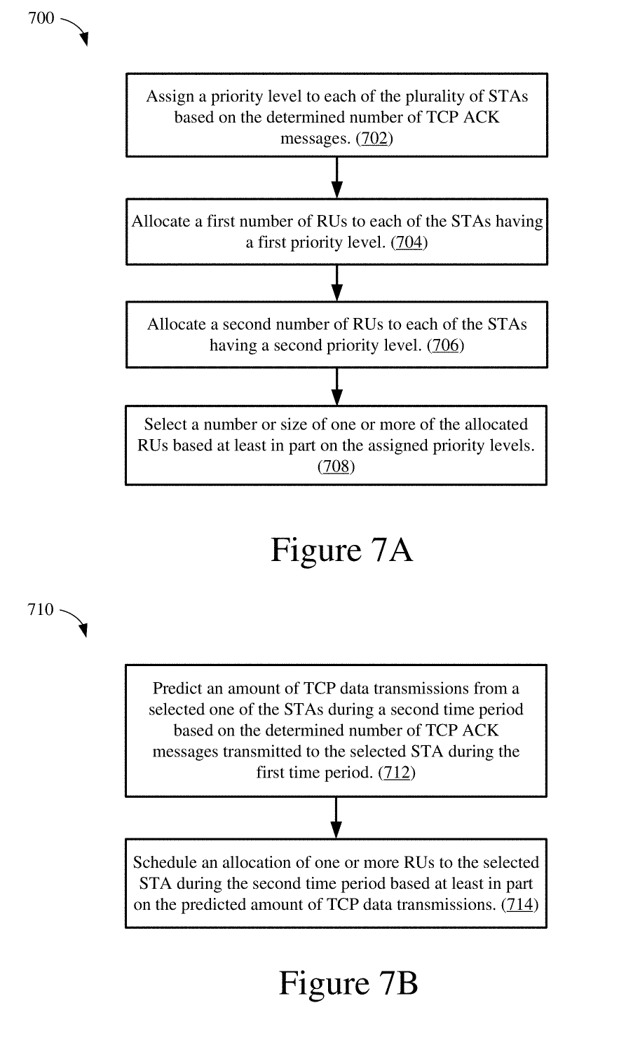

The stations STA1-STA4 may be any suitable Wi-Fi enabled wireless devices including, for example, cell phones, personal digital assistants (PDAs), tablet devices, laptop computers, or the like. The stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below with respect to FIGS. 6A-6B and FIGS. 7A-7B.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below with respect to FIGS. 6A-6B and FIGS. 7A-7B. In some implementations, one or more functions of an AP, such as the AP 110, may be performed by a station, such as one of the stations STA1-STA4 (for example, when the station is operating as a soft AP).

The one or more transceivers in each of stations STA1-STA4 and AP 110 may include Wi-Fi transceivers, Bluetooth transceivers, cellular transceivers, or other suitable radio frequency (RF) transceivers (not shown for simplicity) to transmit and receive wireless communication signals. Each transceiver may communicate with other wireless devices in distinct frequency bands or using distinct communication protocols. For example, the Wi-Fi transceiver may communicate within a 2.4 GHz frequency band, within a 5 GHz frequency band, or within a 60 GHz frequency band in accordance with the IEEE 802.11 family of specifications. The cellular transceiver may communicate within various RF frequency bands in accordance with the LTE protocol described by the 3rd Generation Partnership Project (3GPP) (such as between approximately 700 MHz and approximately 3.9 GHz) or in accordance with other cellular protocols (such as the GSM protocol). In some implementations, the transceivers included within the stations STA1-STA4 or the AP 110 may be any technically feasible transceiver such as a ZigBee transceiver described by a specification from the ZigBee Alliance, a WiGig transceiver, or a HomePlug transceiver described by a specification from the HomePlug Alliance.

In some implementations, the AP 110 may schedule or manage downlink (DL) and uplink (UL) communications associated with the WLAN 120. The AP 110 may selectively allocate unique portions (such as subcarriers) of the available bandwidth of the WLAN 120 to different stations STA1-STA4 so that multiple stations STA1-STA4 can concurrently transmit or receive data during the same transmit opportunity (TXOP). For one example, the AP 110 may schedule queued DL data to be concurrently transmitted to multiple STAs during a DL TXOP. For another example, the AP 110 may schedule or solicit multiple STAs to concurrently transmit UL data during a UL TXOP.

The IEEE 802.11ax specification defines a logical grouping or collection of subcarriers as a “resource unit” (RU) that may be allocated to a specific wireless device (or group of wireless devices) for UL or DL transmissions. In some implementations, the AP 110 may prioritize a number of wireless devices (such as the stations STA1-STA4) based on one or more parameters, and then allocate RUs to the wireless devices based at least in part on their respective priorities. The one or more parameters may include a number of TCP ACK messages received by each of the wireless devices, a level of traffic on the wireless network, or any other suitable parameter or metric that may affect performance of a wireless device or the wireless network.

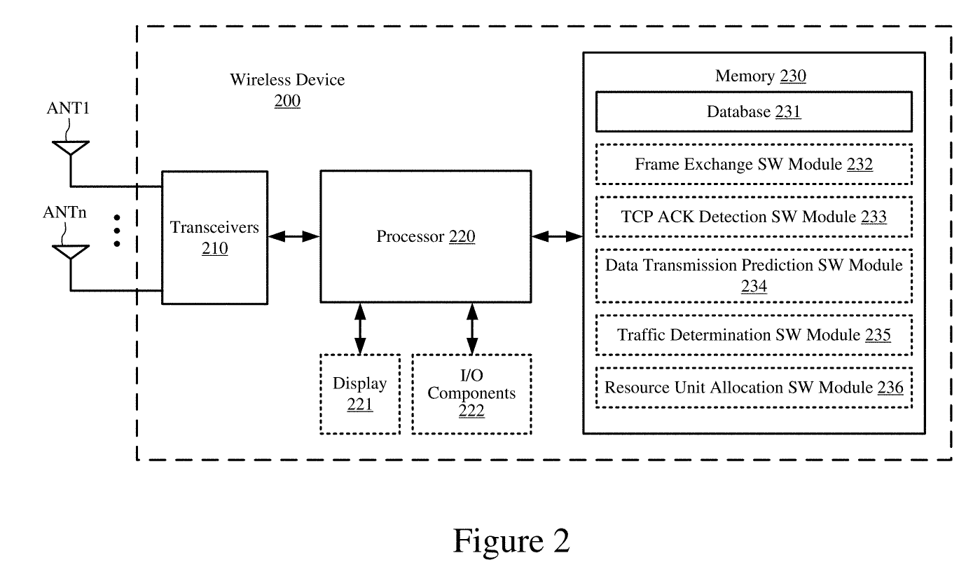

FIG. 2 shows a block diagram of an example wireless device 200. The example wireless device 200 may be one implementation of at least one of the stations STA1-STA4 or the AP 110 of FIG. 1. The wireless device 200 may include one or more transceivers 210, a processor 220, a memory 230, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, the AP 110 or one or more of the stations STA1-STA4 of FIG. 1. Although not shown in FIG. 2 for simplicity, the transceivers 210 may include any number of transmit chains to process and transmit signals to other wireless devices via the antennas ANT1-ANTn, and may include any number of receive chains to process signals received from the antennas ANT1-ANTn. Thus, the wireless device 200 may be configured for MIMO operations. The MIMO operations may include SU-MIMO operations and MU-MIMO operations. In addition, the wireless device 200 may be configured for OFDMA communications and/or other suitable multiple access mechanisms, for example, as may be provided in the IEEE 802.11ax standards.

Further, in some aspects, the wireless device 200 may use multiple antennas ANT1-ANTn to provide antenna diversity. Antenna diversity may include polarization diversity, pattern diversity, and spatial diversity. For purposes of discussion herein, the processor 220 is shown as coupled between the transceivers 210 and the memory 230. For actual implementations, the transceivers 210, the processor 220, and the memory 230 may be connected together using one or more buses (not shown for simplicity).

In some implementations (such as when the wireless device 200 is a wireless station), the wireless device 200 may optionally include (or be coupled to) a display 221 and a user interface 222. The display 221 may be any suitable display or screen allowing for user interaction and/or to present items or data to a user. In some aspects, the display 221 may be a touch-sensitive display. The I/O components 222 may be or include any suitable mechanism, interface, or device to receive input (such as commands) from the user and to provide output to the user. For example, the I/O components 222 may include (but are not limited to) a graphical user interface, keyboard, mouse, microphone and speakers, and so on.

The memory 230 may include a database 231 that may store location data, configuration information, data rates, MAC addresses, timing information, modulation and coding schemes, channel information, received signal strength indicator (RSSI) values, goodput values, channel state information (CSI), supported data rates, and/or other suitable information about (or pertaining to) a number of access points, stations, and other wireless devices. The database 231 also may store a number of TCP ACK messages received by each of a number of wireless stations during one or more time periods, an amount of aggregated data units transmitted or received by each of a number of wireless stations during one or more time periods, and levels of traffic on the wireless network during one or more time periods. The database 231 also may store predicted amounts of TCP data transmissions for each of a number of wireless stations for one or more subsequent time periods.

The memory 230 also may include a non-transitory computer-readable storage medium (such as one or more nonvolatile memory elements, such as EPROM, EEPROM, Flash memory, a hard drive, and so on) that may store the following software modules:
a frame exchange software module 232 to create and exchange frames (such as data frames, control frames, management frames, and trigger frames) between the wireless device 200 and other wireless devices, for example, as described below with respect to FIGS. 6A-6B and FIGS. 7A-7B;
a TCP ACK detection software module 233 to determine a number of TCP ACK messages transmitted or received by each of a number of STAs during one or more time periods, for example, as described below with respect to FIGS. 6A-6B and FIGS. 7A-7B;
a data transmission prediction software module 234 to predict an amount of TCP data that may be transmitted by each of a number of STAs for one or more subsequent time periods, for example, as described below with respect to FIGS. 6A-6B and FIGS. 7A-7B;
a traffic determination software module 235 to determine levels of traffic on the wireless network, for example, as described below with respect to FIGS. 6A-6B and FIGS. 7A-7B; and
a resource unit allocation software module 236 to allocate RUs to one or more STAs in the wireless network based at least in part on the predicted amounts of TCP data transmissions, for example, as described below with respect to FIGS. 6A-6B and FIGS. 7A-7B.
   Each software module includes instructions that, when executed by the processor 220, may cause the wireless device 200 to perform the corresponding functions. The non-transitory computer-readable medium of the memory 230 thus includes instructions for performing all or a portion of the operations described below with respect to FIGS. 6A-6B and FIGS. 7A-7B.

The processor 220 may be any one or more suitable processors capable of executing scripts or instructions of one or more software programs stored in wireless device 200 (such as within the memory 230). The processor 220 may execute the frame exchange software module 232 to create and exchange frames (such as data frames, control frames, management frames, and trigger frames) between the wireless device 200 and other wireless devices. In some implementations, the processor 220 may execute the frame exchange software module 232 to generate and transmit a trigger frame that allocates a number of RUs to one or more STAs for uplink (UL) data transmissions, for downlink (DL) data transmissions, or both.

The processor 220 may execute the TCP ACK detection software module 233 to determine a number of TCP ACK messages transmitted or received by each of a number of STAs during one or more time periods. When a STA transmits TCP data to one or more other devices, the STA receives a number of TCP ACK messages confirming reception of the transmitted TCP data. The number of TCP ACK messages received by the STA may provide an indication of an amount of additional TCP data expected to be transmitted by the STA.

The processor 220 may execute the data transmission prediction software module 234 to predict an amount of TCP data that may be transmitted by each of a number of STAs during one or more subsequent time periods. In some implementations, the number of TCP ACK messages received by a STA during a first time period may be used to predict an amount of TCP data transmissions by the STA during a second time period that is after the first time period (such as in a next or subsequent TXOP). The predicted amount of TCP data transmissions may be used to schedule the allocation of one or more RUs to the STA during the second time period, for example, to ensure that sufficient resources of the wireless network will be available to accommodate subsequent TCP data transmissions from the STA.

The processor 220 may execute the traffic determination software module 235 to determine network traffic conditions of the wireless network. In some aspects, execution of the traffic determination software module 235 may determine a level of traffic on the wireless network, which may be used to determine whether to postpone transmission of a trigger frame. For example, execution of the traffic determination software module 235 may indicate a high-traffic condition if the level of traffic is greater than a value, and may indicate a low-traffic condition if the level of traffic is not greater than the value. In other aspects, execution of the traffic determination software module 235 may determine a load on the wireless network, which may be used as a factor when allocating wireless medium resources to one or more STAs.

The processor 220 may execute the resource unit allocation software module 236 to allocate RUs to one or more STAs in the wireless network based at least in part on the predicted amounts of TCP data transmissions. In some implementations, execution of the resource unit allocation software module 236 may allocate wireless medium resources to one or more STAs based on the number of TCP ACK messages that were received by each of the STAs during one or more previous time periods. In some aspects, the wireless device 200 may allocate a greater amount of RUs to STAs that received a relatively large number of TCP ACK messages than to STAs that received a relatively small number of TCP ACK messages (or no TCP ACK messages) during a given time period. In other aspects, the wireless device 200 may adjust the number or size of RUs allocated to a respective STA during a second time period based on the number of TCP ACK messages that were received by the respective STA during a first time period.

Although functionality is described above with respect to software modules, in some implementations, an equivalent functionality may be provided by hardware modules, firmware modules, or any feasible combination of hardware, firmware, and software modules (not shown for simplicity).

As mentioned above, the IEEE 802.11ax specification may introduce multiple access mechanisms, such as an orthogonal frequency-division multiple access (OFDMA) mechanism, to allow multiple STAs to transmit and receive data on a shared wireless medium at the same time. For a wireless network using OFDMA, the available frequency spectrum may be divided into a plurality of resource units (RUs) each including a number of different frequency subcarriers. Different RUs may be allocated or assigned to different wireless devices (such as STAs) at a given point in time. In this manner, multiple wireless devices may concurrently transmit data on the wireless medium using their assigned RUs (and their respective frequency subcarriers). Because each RU may include a subset of the available frequency subcarriers that is much smaller than the overall frequency spectrum of the wireless medium, the IEEE 802.11ax specification may allow wireless devices to transmit data to each other using smaller channel bandwidths of 2 MHz, 4 MHz, 8 MHz, and 16 MHz (such as compared to a primary 20 MHz channel and one or more secondary channels of varying bandwidths).

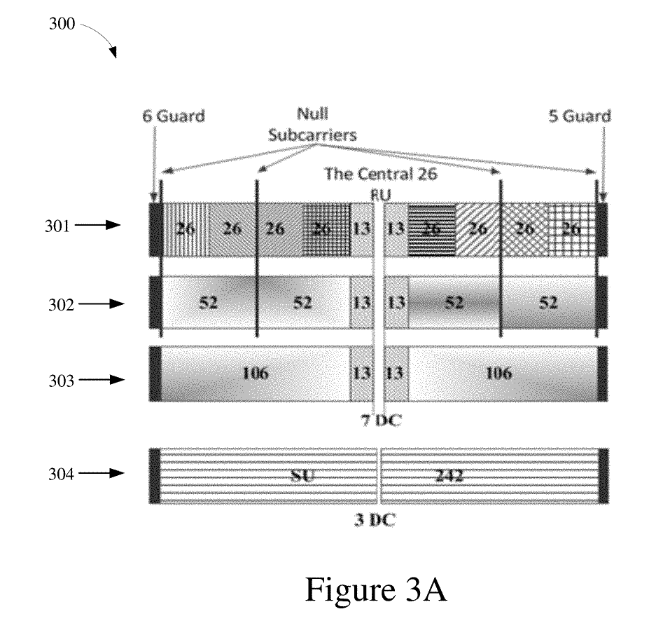

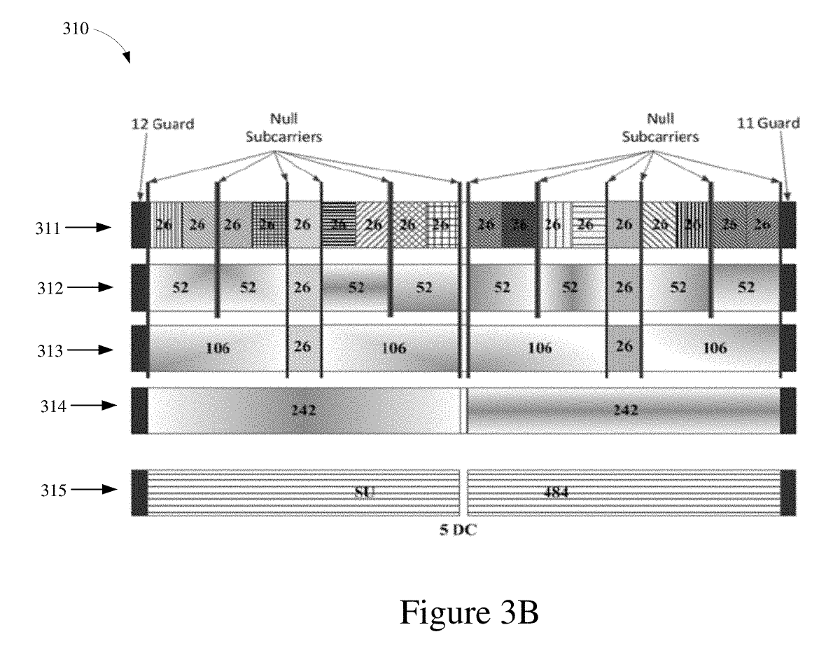

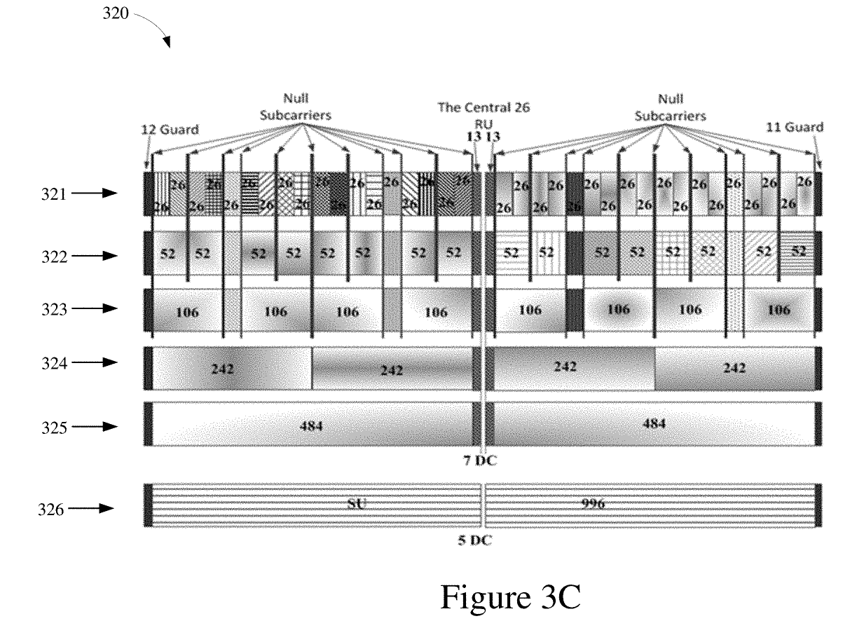

FIGS. 3A-3C show example subcarrier allocations and resource unit (RU) distributions within different channel bandwidths. FIG. 3A shows a subcarrier allocation diagram 300 for a 20 MHz bandwidth according to the draft IEEE 802.11ax specification. As shown in FIG. 3A, a 20 MHz bandwidth may be divided into a number of resource units (RUs), and each RU may include a number of subcarriers. For example, a first subcarrier allocation 301 may include a number of RUs each including 26 subcarriers, a second subcarrier allocation 302 may include a number of RUs each including 52 subcarriers, a third subcarrier allocation 303 may include a number of RUs each including 106 subcarriers, and a fourth subcarrier allocation 304 may include one RU including 242 subcarriers. For each of the example subcarrier allocations 301-304 depicted in FIG. 3A, adjacent RUs may be separated by a null subcarrier (e.g., a DC subcarrier), for example, to reduce leakage between adjacent RUs.

FIG. 3B shows a subcarrier allocation diagram 310 for a 40 MHz bandwidth according to the draft IEEE 802.11ax specification. As shown in FIG. 3B, a 40 MHz bandwidth may be divided into a number of RUs, and each RU may include a number of subcarriers. For example, a first subcarrier allocation 311 may include a number of RUs each including 26 subcarriers, a second subcarrier allocation 312 may include a number of RUs each including 52 subcarriers, a third subcarrier allocation 313 may include a number of RUs each including 106 subcarriers, a fourth subcarrier allocation 314 may include a number of RUs each including 242 subcarriers, and a fifth subcarrier allocation 315 may include one RU including 484 subcarriers. For each of the example subcarrier allocations 311-316 depicted in FIG. 3B, adjacent RUs may be separated by a null subcarrier, for example, to reduce leakage between adjacent RUs.

FIG. 3C shows a subcarrier allocation diagram 320 for an 80 MHz bandwidth according to the draft IEEE 802.11ax specification. As shown in FIG. 3C, an 80 MHz bandwidth may be divided into a number of resource units (RUs), and each RU may include a number of subcarriers. For example, a first subcarrier allocation 321 may include a number of RUs each including 26 subcarriers, a second subcarrier allocation 322 may include a number of RUs each including 52 subcarriers, a third subcarrier allocation 323 may include a number of RUs each including 106 subcarriers, a fourth subcarrier allocation 324 may include a number of RUs each including 242 subcarriers, a fifth subcarrier allocation 325 may include a number of RUs each including 484 subcarriers, and a sixth subcarrier allocation 326 may include one RU including 996 subcarriers. For each of the example subcarrier allocations 321-326 depicted in FIG. 3C, adjacent RUs may be separated by a null subcarrier, for example, to reduce leakage between adjacent RUs.

The IEEE 802.11ax specification may allow an AP to solicit UL data transmissions from one or more associated stations using trigger frames, and may allow the AP to schedule the delivery of queued DL data to one or more associated stations using trigger frames. In this manner, trigger frames may be used to schedule UL transmissions from multiple stations at the same time, and may be used to schedule DL transmissions to multiple stations at the same time. For example, a trigger frame may identify a number of stations for whom an AP has queued DL data, and may allocate different resource units (RUs) to each of the identified stations. In some aspects, the trigger frame may indicate the size and location of the RU(s) allocated to each of the stations identified by the trigger frame. The trigger frame may also solicit UL transmissions from one or more identified stations, for example, by causing the one or more stations to transmit UL data beginning at some time period after receipt of the trigger frame. The one or more identified stations may concurrently transmit UL data using the RUs allocated by the trigger frame. In some aspects, the trigger frame may also indicate the MCS and the transmit power level to be used by each of the stations for transmitting UL data.

As mentioned above, scheduling access to the wireless medium by allocating RUs to a number of STAs may affect communication efficiency of the STAs and the wireless network. Aspects of the present disclosure may reduce network congestion and undesirable transmission latencies (such as compared with conventional wireless networks) by predicting an amount of future data transmissions for each of the STAs, and dynamically adjusting the size, the number, and/or the periodicity of RUs allocated to each of the STAs based on the predicted amount of future data transmissions. For example, because a STA typically requests more data in response to receiving a TCP ACK message, the number of TCP ACK messages received by a respective STA may be used to predict an amount of TCP data to be transmitted or received by the STA during one or more subsequent time periods. In some implementations, the predicted amounts of TCP data that may be transmitted or received by each of the STAs may be used to schedule allocations of RUs to the STAs for a number of subsequent TXOPs. In some aspects, a greater amount of RUs may be allocated to STAs which are predicted to transmit or receive a relatively large amount of TCP data than to STAs which are predicted to transmit or receive a relatively small amount (or no amount) of TCP data. In other aspects, RUs may be allocated more frequently to STAs which are predicted to transmit or receive a relatively large amount of TCP data than to STAs which are predicted to transmit or receive a relatively small amount (or no amount) of TCP data. In this manner, aspects of the present disclosure may ensure that sufficient network resources are (and will be) available to accommodate data transmissions associated with ongoing TCP sessions.

As used herein, an “amount” of RUs allocated in a TXOP may refer to the number of RUs allocated in the TXOP, the size of the RUs allocated in the TXOP, or to both the number and the size of the RUs allocated in the TXOP. As such, adjusting (for example, increasing or decreasing) an amount of allocated RUs may include adjusting a number of RUs allocated, a size of RUs allocated or both a number and a size of RUs allocated in a TXOP. Adjusting an RU allocation also may include adjusting a frequency with which RUs are allocated to a given STA (for example, how often a given STA is scheduled for participation in TXOPs).

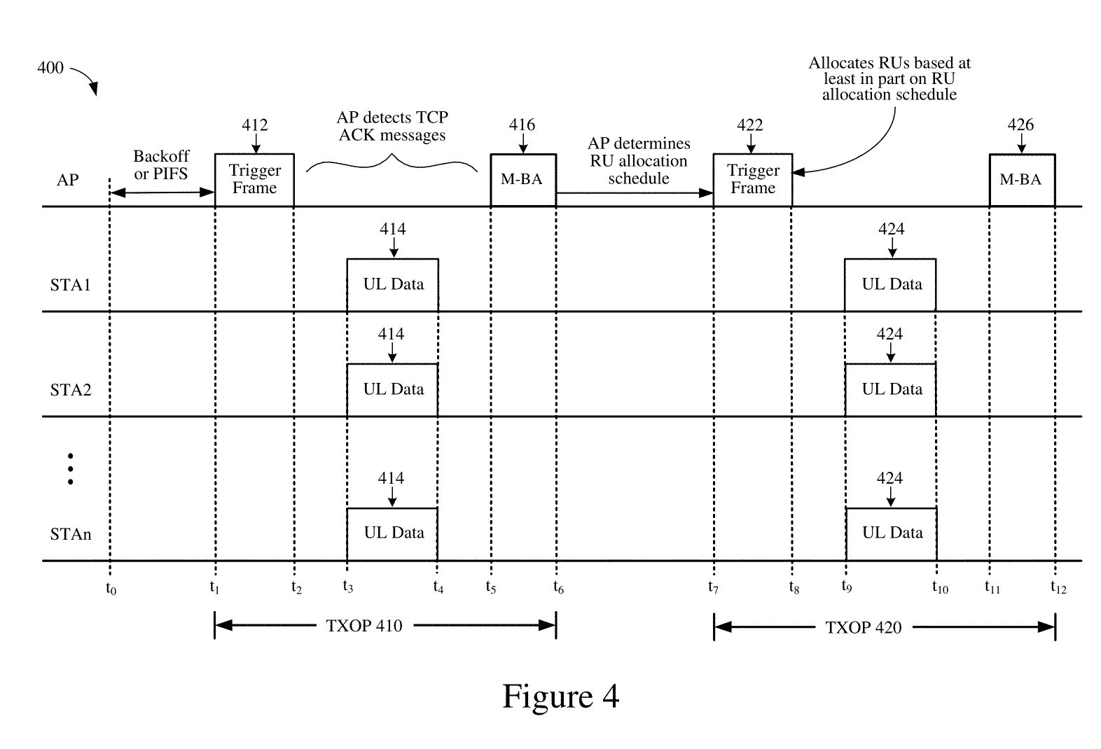

FIG. 4 shows a timing diagram 400 depicting an example operation using trigger frames to allocate resource units (RUs) to one or more wireless stations. The AP of FIG. 4 may be any suitable AP including, for example, the AP 110 of FIG. 1 or the wireless device 200 of FIG. 2. Each of the wireless stations STA1-STAn may be any suitable wireless station including, for example, the stations STA1-STA4 of FIG. 1 or the wireless device 200 of FIG. 2.

In some implementations, the AP may contend for medium access during a backoff period or a point coordination function (PCF) interframe space (PIFS) duration (such as between times t₀ and t₁). In other implementations, the AP may contend for medium access using another suitable channel access mechanism. In some other implementations, the AP may utilize a multiple channel access mechanism, for example, and may not contend for medium access.

The AP gains access to the wireless medium at time t₁, and transmits a first trigger frame 412 to the stations STA1-STAn on a downlink (DL) channel. The stations STA1-STAn receive the first trigger frame 412 at time t₂. The first trigger frame 412 may indicate a beginning of a first transmit opportunity (TXOP) 410. The first trigger frame 412 may allocate one or more RUs to each of the stations STA1-STAn identified by the first trigger frame 412, and may solicit uplink multi-user (UL MU) data transmissions from the identified stations STA1-STAn. For the example of FIG. 4, all of the stations STA1-STAn are allocated RUs upon which to transmit UL data to the AP. In some aspects, the first trigger frame 412 may schedule UL data transmissions from the identified stations STA1-STAn to commence at an unspecified interframe spacing (xIFS) duration after reception of the first trigger frame 412.

At time t₃, the stations STA1-STAn begin transmitting the scheduled UL MU data 414 using the RUs allocated by the first trigger frame 412. In some aspects, each of the stations STA1-STAn identified by the first trigger frame 412 may determine whether the frequency band associated with its allocated RU has been idle for a duration (such as a PIFS duration) prior to transmitting UL MU data to the AP. The AP may receive the UL data 414 transmitted from the identified stations STA1-STAn at time t₄, and may acknowledge reception of the UL MU data 414 from the stations STA1-STAn by transmitting one or more acknowledgement (ACK) frames to the stations STA1-STAn at time t₅. In some aspects, the AP may acknowledge reception of the UL MU data 414 by transmitting a MU ACK frame to the stations STA1-STAn. In other aspects, the AP may acknowledge reception of the UL MU data 414 by transmitting a multi-station block acknowledgement (M-BA) frame 416 to the stations STA1-STAn, for example, as depicted in the example of FIG. 4. The stations STA1-STAn may receive the M-BA frame 416 at time t₆.

In some implementations, the AP may determine a number of transmission control protocol (TCP) acknowledgement (ACK) messages transmitted to (and received by) each of the stations STA1-STAn during the first TXOP 410, and may determine an RU allocation schedule that allocates RUs to one or more of the STAs for the second TXOP 420 based at least in part on the determined numbers of TCP ACK messages transmitted to and received by each of the stations STA1-STAn during the first TXOP 410. In some aspects, the AP may use the number of TCP ACK messages received by each of the stations STA1-STAn during the first TXOP 410 to predict an amount of TCP data that may be transmitted by one or more of the stations STA1-STAn during the second TXOP 420, and may allocate RUs to one or more of the stations STA1-STAn for the second TXOP 420 based at least in part on the predicted amounts of TCP data transmissions. In this manner, the AP may ensure that sufficient resources of the wireless network are (and will be) available to accommodate TCP data transmissions from the stations STA1-STAn during the second TXOP 420.

After expiration of the first TXOP 410, the AP gains access to the wireless medium and transmits a second trigger frame 422 to the stations STA1-STAn on the DL channel at time t₇. The stations STA1-STAn receive the second trigger frame at time t₈. The second trigger frame 422 may indicate the beginning of the second TXOP 420. The second trigger frame 422 may allocate RUs to one or more of the stations STA1-STAn based on the RU allocation schedule determined after the first TXOP 410. In some aspects, the number and size of the RUs allocated by the second trigger frame 422 may be based on the numbers of TCP ACK messages received by the stations STA1-STAn during the first TXOP 410 (or during any other suitable time period). In other aspects, the frequency with which the RUs are allocated to the STAs by trigger frames may be based on the numbers of TCP ACK messages received by the stations STA1-STAn during the first TXOP 410 (or during any other suitable time period).

At time t9, the stations STA1-STAn begin transmitting the scheduled UL MU data 424 using the RUs allocated by the second trigger frame 422. The AP receives the UL data 424 transmitted from the identified stations STA1-STAn at time t₁₀, and may acknowledge reception of the UL MU data 424 from the stations STA1-STAn by transmitting one or more ACK frames (such as M-BA frames 426) to the stations STA1-STAn at time t₁₁. The stations STA1-STAn receive the M-BA frame 426 at time t12.

In some implementations, the AP may selectively transmit the trigger frames 412 and 422 based on the level of traffic in the wireless network. For example, to avoid increasing network congestion by allocating RUs to STAs based on numbers of received TCP ACK messages, the AP may postpone transmission of the trigger frames 412 and 422 when a high traffic condition exists in the wireless network. In some aspects, the AP may indicate a high traffic condition when the level of network traffic is greater than a value, and may indicate a low traffic condition when the level of network traffic is not greater than the value.

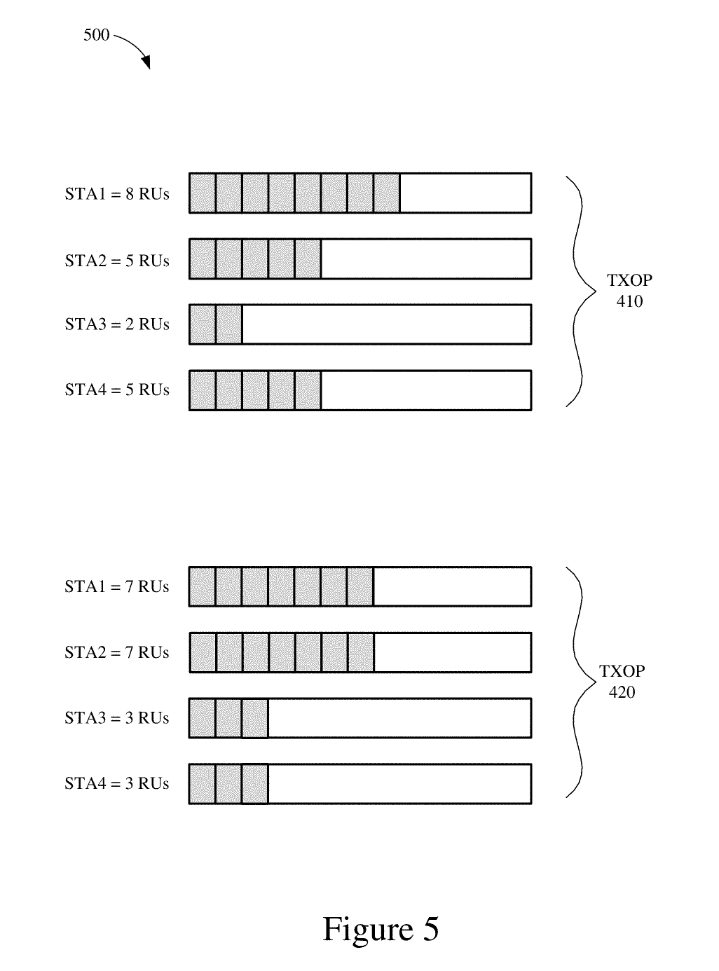

FIG. 5 shows an illustration 500 depicting an example scheduled allocation of resource units based on a number of transmission control protocol (TCP) acknowledgement (ACK) messages received by the wireless devices. Referring also to FIG. 4, during the first TXOP 410, the AP may not have yet determined whether some or all of the stations STA1-STAn received TCP ACK messages, for example, because the first TXOP 410 may correspond to an initial exchange of data with one or more of the stations STA1-STAn in the wireless network. In this case, the AP may initially allocate a number of RUs to one or more of the stations STA1-STAn using other criteria. In instances in which the AP has previously facilitated the exchange of data to or from one or more of the stations STA1-STAn, the AP may allocate RUs to these stations based on the predicted amount of TCP data that may be transmitted by the respective stations STA1-STAn during the first TXOP 410. In the example illustrated in FIG. 5, the first trigger frame 412 initially allocates 8 RUs to STA1, allocates 5 RUs to STA2, allocates 2 RUs to STA3, and allocates 5 RUs to STA4 during the first TXOP 410. During the first TXOP 410, the AP may detect TCP ACK messages transmitted in the wireless network, and may determine a number of TCP ACK messages received by each of the stations STA1-STAn.

In the example of FIG. 5, the stations STA1 and STA2 each received a first number of TCP ACK messages during the first TXOP 410, and the stations STA3 and STA4 each received a second number of TCP ACK messages during the first TXOP 410 that is greater than the second number. After receiving the UL MU data 414 in the first TXOP 410, for example, during any portion of the time period between times t₄ and t₇, the AP may schedule an allocation of RUs for the subsequent second TXOP 420 to the stations STA1-STA4 based on the numbers of TCP ACK messages received by the stations STA1-STAn during the first TXOP 410. Because the reception of TCP ACK messages by a respective STA may indicate a number of subsequent TCP data transmissions expected from the respective STA, the AP may allocate a greater amount of RUs to STAs which are expected to transmit more TCP data, and may allocate a fewer amount of RUs to STAs which are expected to transmit less TCP data. Thus, as depicted in the example of FIG. 5, the AP allocates 7 RUs to STA1, allocates 7 RUs to STA2, allocates 3 RUs to STA3, and allocates 3 RUs to STA4 during the second TXOP 420. In this manner, the AP may reserve sufficient resources of the wireless network to ensure that each of the stations STA1-STA4 is able to continue transmitting TCP data during the second TXOP 420.

FIG. 6A shows an illustrative flow chart depicting an example operation 600 for allocating wireless medium resources to wireless devices. The operation 600 may be performed by the wireless device 200 of FIG. 2. In some implementations, the operation 600 may be performed by the processor 220 executing any feasible software or instructions stored within the memory 230 of the wireless device 200. In other implementations, the operation 600 may be performed by hardware modules, firmware modules, or any feasible combination of hardware, firmware, and software modules included within the wireless device 200. In some other implementations, the operation 600 may be performed by any suitable wireless device including, for example, the AP 110 of FIG. 1.

The wireless device 200 may determine a number of transmission control protocol (TCP) acknowledgement (ACK) messages transmitted to (and received by) each of a plurality of stations (STAs) in a wireless network during a first time period (602). For example, the first time period may correspond to a current or previous TXOP. As discussed above, when a STA transmits TCP data to another device, the STA receives a number of TCP ACK messages confirming reception of the transmitted TCP data by the other device. In some aspects, the wireless device 200 may operate as an AP, and may route TCP ACK messages from the other device to the STA. In this manner, the wireless device 200 may be able to monitor the transmission of TCP ACK messages to each of the STAs in the wireless network. The first time period may be a predetermined time period, a fixed time period, or a variable time period.

The wireless device 200 may allocate a number of resource units (RUs) to one or more of the STAs during a second time period based at least in part on the determined numbers of TCP ACK messages for the first time period (604). For example, the second time period may correspond to a next or subsequent TXOP. The transmission of TCP ACK messages to a given STA may indicate that the given STA is likely to continue transmitting TCP data. In some implementations, the number of TCP ACK messages received by a given STA during the first time period may be used to predict an amount of TCP data that will be transmitted by the given STA during the second time period. The predicted amount of TCP data to be transmitted by the given STA may be used to determine an amount of UL resources needed by the given STA, and to schedule an allocation of the determined amount of UL resources to the given STA during the second time period (or a number of additional future time periods). In this manner, the wireless device 200 may ensure that sufficient resources of the wireless network will be available to accommodate future TCP data transmissions from the given STA.

FIG. 6B shows an illustrative flow chart depicting an example operation 604′ for allocating a number of RUs to one or more wireless devices. The operation 604′ may be one implementation of the operation 604 of FIG. 6A. For example, the allocation operation 604′ can be used to allocate a number of RUs to one station during a second time period based at least in part on the determined numbers of TCP ACK messages for a first time period. In some aspects, the wireless device 200 may select a number or size (or both) of one or more of the allocated RUs based at least in part on the determined numbers of TCP ACK messages (604A). In some implementations, the wireless device 200 may also adjust the frequency with which the RUs are allocated to the STAs based on the determined numbers of TCP ACK messages (604B).

The wireless device 200 may transmit a trigger frame indicating the allocation of the number of RUs to the one or more STAs for the second time period (606). The trigger frame may identify each of the one or more STAs that have been allocated RUs, and may identify the size and location of the RU(s) allocated to each of the one or more STAs. In some aspects, the trigger frame may also indicate the MCS and power level to be used by each of the identified STAs when transmitting UL data (such to the wireless device 200).

In some implementations, the wireless device 200 may selectively transmit the trigger frame based on whether a high traffic condition exists in the wireless network. Allocating RUs to STAs based on numbers of received TCP ACK messages may increase network congestion, especially during high traffic conditions. To avoid increasing network congestion, the wireless device 200 may not transmit the trigger frame when a high traffic condition exists within the wireless network.

FIG. 6C shows an illustrative flow chart depicting an example operation 606′ for transmitting a trigger frame. The operation 606′ may be one implementation of the operation 606 of FIG. 6A. For example, the trigger frame transmission operation 606′ can be used to transmit a trigger frame indicating the allocation of the number of RUs to one or more STAs for the second time period. In some aspects, the wireless device 200 may indicate a high traffic condition based on a level of traffic in the wireless network exceeding a value (606A), and may transmit the trigger frame if the high traffic condition is not indicated (606B). Conversely, if the high traffic condition is indicated, the wireless device 200 may postpone transmission of the trigger frame (606C). The wireless device 200 may continue to monitor network conditions and thereafter transmit the trigger frame when network traffic conditions improve (such as when the high traffic condition no longer exists).

FIG. 7A shows an illustrative flow chart depicting an example operation 700 for allocating a number of resource units to one or more wireless devices. The operation 700 may be one implementation of the operation 604A of FIG. 6B. The operations described herein may be performed individually or in parallel, and may be performed by the wireless device 200 of FIG. 2.

The wireless device 200 may assign a priority level to each of the plurality of STAs based on the determined number of TCP ACK messages (702). STAs that receive a greater number of TCP ACK messages may be assigned higher priority levels than STAs that receive a fewer number of TCP ACK messages. For example, the stations STA1 and STA2 in the example of FIG. 5 may each be assigned a relatively high priority level for allocations of RUs during the second TXOP 420, and the stations STA3 and STA4 in the example of FIG. 5 may each be assigned a relatively low priority level for allocations of RUs during the second TXOP 420. As depicted in the example of FIG. 5, the stations STA1 and STA2 are each allocated 7 RUs for the second TXOP 420 based on their relatively high priority level, and the stations STA3 and STA4 are each allocated 3 RUs for the second TXOP 420 based on their relatively low priority level.

The wireless device 200 may allocate a first number of RUs to each of the STAs having a first priority level (704), and may allocate a second number of RUs to each of the STAs having a second priority level (706). The first number of RUs may be greater than the second number of RUs, and the first priority level may be higher than the second priority level, for example, so that STAs having higher priority levels may be allocated a greater amount of RUs than STAs having lower priority levels. In addition, if there are not enough available RUs to accommodate the UL transmissions of all the STAs in the wireless network, then the available RUs may be allocated to the STA in decreasing order of priority levels. In some aspects, the wireless device 200 may select a number or size of one or more of the allocated RUs based at least in part on the assigned priority levels (708).

FIG. 7B shows an illustrative flow chart depicting another example operation 710 for allocating a number of resource units to one or more wireless devices. The operation 710 may be one implementation of the operation 604 of FIG. 6A. The operations described herein may be performed individually or in parallel, and may be performed by the wireless device 200 of FIG. 2.

The wireless device 200 may predict an amount of TCP data transmissions from a selected one of the STAs during a second time period based on the determined number of TCP ACK messages transmitted to the selected STA during the first time period (712). As discussed above, because the transmission of TCP ACK messages to a given STA may indicate that the given STA is likely to continue transmitting TCP data, the number of TCP ACK messages received by a given STA during the first time period may be used to predict an amount of TCP data that will be transmitted by the given STA during the second time period.

The wireless device 200 may schedule an allocation of one or more RUs to the selected STA during the second time period based at least in part on the predicted amount of TCP data transmissions (714). As discussed above, the predicted amount of TCP data to be transmitted by the given STA may be used to determine an amount of UL resources needed by the given STA during the second time period. To ensure that the given STA may continue transmitting TCP data, the wireless device 200 may schedule the allocation of the determined amount of UL resources to the given STA during the second time period.

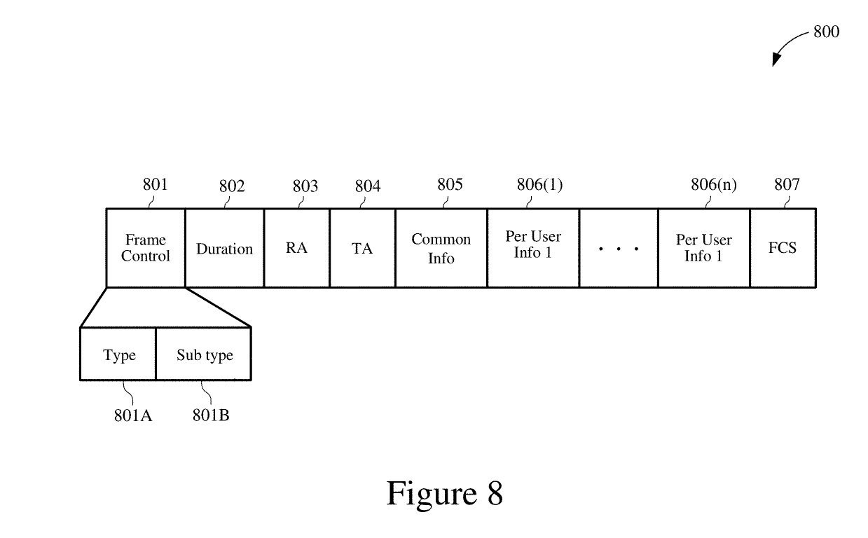

FIG. 8 shows an example trigger frame 800. The trigger frame 800 may be used as the trigger frames 412 and 422 of FIG. 4. The trigger frame 800 is shown to include a frame control field 801, a duration field 802, a receiver address (RA) field 803, a transmitter address (TA) field 804, a Common Info field 805, a number of Per User Info fields 806(1)-806(n), and a frame check sequence (FCS) field 807.

The frame control field 801 includes a Type field 801A and a Sub-type field 801B. The Type field 801A may store a value to indicate that the trigger frame 800 is a control frame, and the Sub-type field 801B may store a value indicating a type of the trigger frame 800. The duration field 802 may store information indicating a duration or length of the trigger frame 800. The RA field 803 may store the address of a receiving device (such as one of the wireless stations STA1-STAn of FIG. 4). The TA field 804 may store the address of a transmitting device (such as the AP of FIG. 4). The Common Info field 805 may store information common to one or more receiving devices (such as one of the wireless stations STA1-STAn of FIG. 4). Each of the Per User Info fields 806(1)-806(n) may store information for a particular receiving device including, for example, the AID of the receiving device. The FCS field 807 may store a frame check sequence (such as for error detection).

In some aspects, the trigger frame 800 may allocate dedicated RUs to associated STAs identified by AID values stored in corresponding ones of the Per User Info fields 806(1)-806(n). In other aspects, the trigger frame 800 may allocate random RUs to one or more groups of STAs using pre-defined AID values stored in the Per User Info fields 806(1)-806(n).

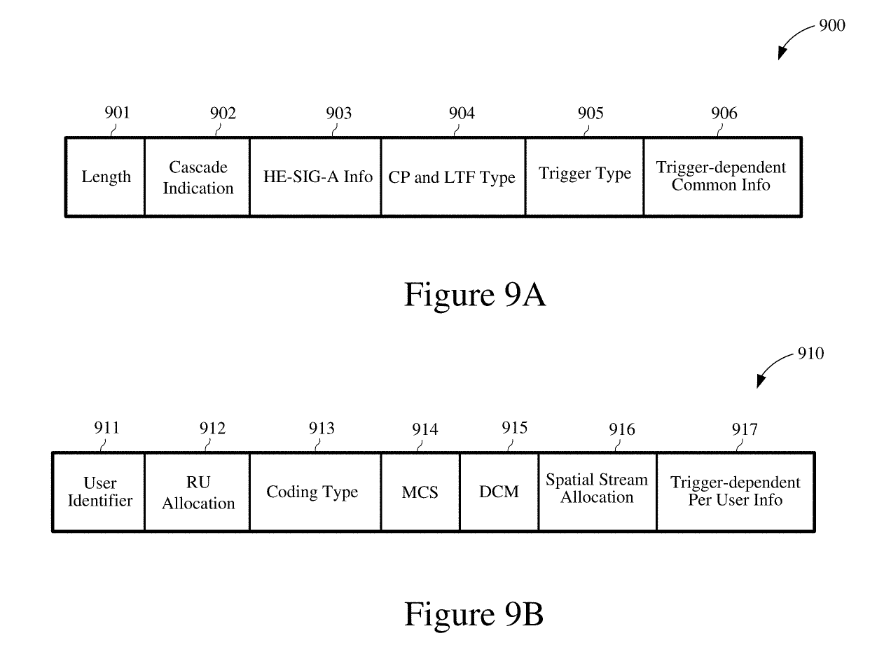

FIG. 9A shows an example Common Info field 900. The Common Info field 900 may be one implementation of the Common Info field 805 of the trigger frame 800 of FIG. 8. The Common Info field 900 is shown to include a length subfield 901, a cascade indication subfield 902, a high-efficiency signaling A (HE-SIG-A) info subfield 903, a cyclic prefix (CP) and legacy training field (LTF) type subfield 904, a trigger type subfield 905, and a trigger-dependent common info subfield 906. The length subfield 901 may indicate the length of a legacy signaling field of the UL data frames to be transmitted in response to the trigger frame 800. The cascade indication subfield 902 may indicate whether a subsequent trigger frame follows the current trigger frame. The HE-SIG-A Info subfield 903 may indicate the contents of a HE-SIG-A field of the UL data frames to be transmitted in response to the trigger frame 800. The CP and LTF type subfield 904 may indicate the cyclic prefix and HE-LTF type of the UL data frames to be transmitted in response to the trigger frame 800. The trigger type subfield 905 may indicate the type of trigger frame. The trigger-dependent common info subfield 906 may indicate trigger-dependent information.

FIG. 9B shows an example Per User Info field 910. The Per User Info field 910 may be one implementation of the Per User Info fields 806(1)-806(n) of the trigger frame 800. The Per User Info field 910 is shown to include a User Identifier subfield 911, an RU Allocation subfield 912, a Coding Type subfield 913, an MCS subfield 914, a dual-carrier modulation (DCM) subfield 915, a spatial stream (SS) Allocation subfield 916, and a trigger-dependent Per User info subfield 917. The User Identifier subfield 911 may indicate the association identification (AID) of the STA to which a dedicated RU is allocated for transmitting UL MU data. The RU Allocation subfield 912 may identify the dedicated RU allocated to the corresponding STA (such as the STA identified by the User Identifier subfield 911). The Coding Type subfield 913 may indicate the type of coding to be used by the corresponding STA when transmitting UL data using the allocated RU. The MCS subfield 914 may indicate the MCS to be used by the corresponding STA when transmitting UL data using the allocated RU. The DCM subfield 915 may indicate the dual carrier modulation to be used by the corresponding STA when transmitting UL data using the allocated RU. The SS Allocation subfield 916 may indicate the number of spatial streams to be used by the corresponding STA when transmitting UL data using the allocated RU.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of allocating uplink (UL) resources to a plurality of stations (STAs) in a wireless network, comprising:
determining a number of transmission control protocol (TCP) acknowledgement (ACK) messages transmitted to each of the plurality of STAs during a first time period;
allocating a number of resource units (RUs) to one or more of the STAs during a second time period based at least in part on the determined numbers of TCP ACK messages; and
transmitting a trigger frame indicating the allocation of the number of RUs to the one or more STAs.

2. The method of claim 1, wherein the allocating further comprises:
selecting a size of one or more of the allocated RUs based at least in part on the determined numbers of TCP ACK messages.

3. The method of claim 1, wherein the allocating further comprises:
assigning a priority level to each of the plurality of STAs based on the determined number of TCP ACK messages, wherein allocating the number of RUs to the one or more STAs is further based on the assigned priority levels.

4. The method of claim 3, wherein the allocating further comprises:
allocating a first number of RUs to each of the STAs having a first priority level; and
allocating a second number of RUs to each of the STAs having a second priority level, wherein the first number of RUs is greater than the second number of RUs, and the first priority level is higher than the second priority level.

5. The method of claim 3, wherein the allocating further comprises:
selecting a size of one or more of the allocated RUs based at least in part on the assigned priority levels.

6. The method of claim 3, wherein the number of RUs are allocated only to STAs assigned to a highest priority level.

7. The method of claim 1, wherein the allocating further comprises:
predicting an amount of TCP data transmissions from a selected one of the STAs during the second time period based on the determined number of TCP ACK messages transmitted to the selected STA during the first time period, the second time period after the first time period; and
scheduling an allocation of one or more RUs to the selected STA during the second time period based at least in part on the predicted amount of TCP data transmissions.

8. The method of claim 7, wherein the predicting further comprises:
determining sequence numbers of one or more TCP connections with the selected STA.

9. The method of claim 1, further comprising:
indicating a high traffic condition based on a level of traffic in the wireless network exceeding a value;
transmitting the trigger frame if the high traffic condition is not indicated; and
postponing transmission of the trigger frame if the high-traffic condition is indicated.

10. A wireless device, comprising:
one or more processors; and
a memory configured to store instructions that, when executed by the one or more processors, cause the wireless device to:
determine a number of transmission control protocol (TCP) acknowledgement (ACK) messages transmitted to each of a plurality of stations (STAs) in a wireless network during a first time period;
allocate a number of resource units (RUs) to one or more of the STAs during a second time period based at least in part on the determined numbers of TCP ACK messages; and
transmit a trigger frame indicating the allocation of the number of RUs to the one or more STAs.

11. The wireless device of claim 10, wherein execution of the instructions to allocate causes the wireless device to further:
select a size of one or more of the allocated RUs based at least in part on the determined numbers of TCP ACK messages.

12. The wireless device of claim 10, wherein execution of the instructions to allocate causes the wireless device to further:
assign a priority level to each of the plurality of STAs based on the determined number of TCP ACK messages, wherein allocating the number of RUs to the one or more STAs is further based on the assigned priority levels.

13. The wireless device of claim 12, wherein execution of the instructions to allocate causes the wireless device to further:
allocate a first number of RUs to each of the STAs having a first priority level; and
allocate a second number of RUs to each of the STAs having a second priority level, wherein the first number of RUs is greater than the second number of RUs, and the first priority level is higher than the second priority level.

14. The wireless device of claim 12, wherein execution of the instructions to allocate causes the wireless device to further:
select a size of one or more of the allocated RUs based at least in part on the assigned priority levels.

15. The wireless device of claim 12, wherein the number of RUs are allocated only to STAs assigned to a highest priority level.

16. The wireless device of claim 10, wherein execution of the instructions to allocate causes the wireless device to further:
predict an amount of TCP data transmissions from a selected one of the STAs during the second time period based on the determined number of TCP ACK messages transmitted to the selected STA during the first time period, the second time period after the first time period; and
schedule an allocation of one or more RUs to the selected STA during the second time period based at least in part on the predicted amount of TCP data transmissions.

17. The wireless device of claim 10, wherein execution of the instructions causes the wireless device to further:
indicate a high traffic condition based on a level of traffic in the wireless network exceeding a value;
transmit the trigger frame if the high traffic condition is not indicated; and
postpone transmission of the trigger frame if the high-traffic condition is indicated.

18. A non-transitory computer-readable storage medium comprising instructions that, when executed by one or more processors of a wireless device, cause the wireless device to perform operations comprising:
determining a number of transmission control protocol (TCP) acknowledgement (ACK) messages transmitted to each of the plurality of STAs during a first time period;
allocating a number of resource units (RUs) to one or more of the STAs during a second time period based at least in part on the determined numbers of TCP ACK messages; and
transmitting a trigger frame indicating the allocation of the number of RUs to the one or more STAs.

19. The non-transitory computer-readable storage medium of claim 18, wherein execution of the instructions for allocating a number of RUs causes the wireless device to perform operations further comprising:
selecting a size of one or more of the allocated RUs based at least in part on the determined numbers of TCP ACK messages.

20. The non-transitory computer-readable storage medium of claim 18, wherein execution of the instructions for allocating a number of RUs causes the wireless device to perform operations further comprising:
assigning a priority level to each of the plurality of STAs based on the determined number of TCP ACK messages, wherein allocating the number of RUs to the one or more STAs is further based on the assigned priority levels.

21. The non-transitory computer-readable storage medium of claim 20, wherein execution of the instructions for allocating a number of RUs causes the wireless device to perform operations further comprising:
allocating a first number of RUs to each of the STAs having a first priority level; and
allocating a second number of RUs to each of the STAs having a second priority level, wherein the first number of RUs is greater than the second number of RUs, and the first priority level is higher than the second priority level.

22. The non-transitory computer-readable storage medium of claim 20, wherein execution of the instructions for allocating a number of RUs causes the wireless device to perform operations further comprising:
selecting a size of one or more of the allocated RUs based at least in part on the assigned priority levels.

23. The non-transitory computer-readable storage medium of claim 18, wherein execution of the instructions for allocating a number of RUs causes the wireless device to perform operations further comprising:
predicting an amount of TCP data transmissions from a selected one of the STAs during the second time period based on the determined number of TCP ACK messages transmitted to the selected STA during the first time period, the second time period after the first time period; and
scheduling an allocation of one or more RUs to the selected STA during the second time period based at least in part on the predicted amount of TCP data transmissions.

24. The non-transitory computer-readable storage medium of claim 18, wherein execution of the instructions causes the wireless device to perform operations further comprising:
indicating a high traffic condition based on a level of traffic in the wireless network exceeding a value;
transmitting the trigger frame if the high traffic condition is not indicated; and
postponing transmission of the trigger frame if the high-traffic condition is indicated.

25. A wireless device, comprising:
means for determining a number of transmission control protocol (TCP) acknowledgement (ACK) messages transmitted to each of the plurality of STAs during a first time period;
means for allocating a number of resource units (RUs) to one or more of the STAs during a second time period based at least in part on the determined numbers of TCP ACK messages; and
means for transmitting a trigger frame indicating the allocation of the number of RUs to the one or more STAs.

26. The wireless device of claim 25, wherein the means for allocating further comprises:
means for selecting a size of one or more of the allocated RUs based at least in part on the determined numbers of TCP ACK messages.

27. The wireless device of claim 25, wherein the means for allocating further comprises:
assigning a priority level to each of the plurality of STAs based on the determined number of TCP ACK messages, wherein allocating the number of RUs to the one or more STAs is further based on the assigned priority levels.

28. The wireless device of claim 27, wherein the means for allocating further comprises:
allocating a first number of RUs to each of the STAs having a first priority level; and
allocating a second number of RUs to each of the STAs having a second priority level, wherein the first number of RUs is greater than the second number of RUs, and the first priority level is higher than the second priority level.

29. The wireless device of claim 25, wherein the means for allocating further comprises:
means for predicting an amount of TCP data transmissions from a selected one of the STAs during the second time period based on the determined number of TCP ACK messages transmitted to the selected STA during the first time period, the second time period after the first time period; and
means for scheduling an allocation of one or more RUs to the selected STA during the second time period based at least in part on the predicted amount of TCP data transmissions.

30. The wireless device of claim 25, further comprising:
means for indicating a high traffic condition based on a level of traffic in the wireless network exceeding a value;
means for transmitting the trigger frame if the high traffic condition is not indicated; and
means for postponing transmission of the trigger frame if the high-traffic condition is indicated.
